(19) United States
(12) Patent Application Publication
(10) Pub. No.: US 2026/0233737 A1
(43) Pub. Date: Aug. 13, 2026

(54) MOWING-ROBOT CONTROL SYSTEM, MOWING-ROBOT CONTROL METHOD, AND MOWING ROBOT

(71) Applicant: Shenzhen Muxin Intelligent Technology Co., Ltd., Shenzhen (CN)

(72) Inventors: Honghui ZHANG, Shenzhen (CN); Ying ZHANG, Shenzhen (CN); Jinzhu HUANG, Shenzhen (CN)

(73) Assignee: Shenzhen Muxin Intelligent Technology Co., Ltd., Shenzhen (CN)

(21) Appl. No.: 19/535,196

(22) Filed: Feb. 10, 2026

(30) Foreign Application Priority Data
Feb. 13, 2025 (CN) 202510159998.8

(51) Int. Cl. G05D 1/00

(52) U.S. Cl. CPC B60W 30/10

(57) ABSTRACT

A mowing-robot control system, a mowing-robot control method, and a mowing robot are provided. The system acquires real-time ambient scene information through a bidirectional visual perception system disposed at both the front and rear ends of the body. A navigation and positioning system determines the robot's precise coordinates and constructs an operational navigation path accordingly. Controlled by a central system, a bidirectional movement module directs the chassis to switch seamlessly between forward and backward travel during operation. By integrating visual perception with dual-directional mobility, the robot eliminates the space occupancy and efficiency losses caused by frequent U-turn maneuvers. This configuration significantly enhances maneuverability in complex terrains and narrow passages, minimizes mechanical damage to the lawn, and provides a reliable technological guarantee for high-precision autonomous mowing tasks.

### CROSS-REFERENCE TO RELATED APPLICATIONS

The present disclosure claims priority to Chinese Patent Application No. 202510159998.8, filed on Feb. 13, 2025, the content of all of which is incorporated herein by reference.

### TECHNICAL FIELD

The present disclosure relates to the technical field of automation control, in particular to a mowing-robot control system, a mowing-robot control method, and a mowing robot.

### BACKGROUND

A mowing robot is a type of gardening equipment that can automatically identify an area that needs to be mowed through a built-in sensor and a navigation system. The mowing robot generally has functions such as scheduled operations, random movements, and obstacle avoidance. Therefore, the mowing robot is increasingly replacing manual or ordinary mechanical equipment and becoming an important part of smart home and gardening maintenance automation equipment.

In the prior art, although various automatic control functions of the mowing robot are being improved, the existing mowing robot generally adopts a two-wheel or rear-wheel drive structure that only supports a unidirectional forward operation. During application, in order to complete a turning or U-turn operation on a path, such robot often needs to take up extra space and time, and repeated U-turns lead to reduced operation efficiency. In addition, when operating in a complex terrain or a narrow area, the mowing robot needs to have higher maneuverability and higher adaptability, otherwise the operation efficiency will be low and the likelihood of equipment malfunctions and safety risks will also increase.

Therefore, the prior art needs to be further improved.

### SUMMARY

In view of the above deficiencies in the prior art, the present disclosure provides a mowing-robot control system, a mowing-robot control method, and a mowing robot, aiming to solve the problem that the mowing robot in the prior art only supports a unidirectional forward operation.

In a first aspect, a mowing-robot control system is provided, including: a chassis system, a bidirectional movement module, a bidirectional visual perception system, a navigation and positioning system, and a central control system;
where the chassis system is arranged at a bottom of a body of a mowing robot and is configured to receive a drive signal sent by the bidirectional movement module and execute a forward movement or a backward movement;
the bidirectional visual perception system includes a front visual sensor located at a front end of the body and a rear visual sensor located at a rear end of the body, and the front visual sensor and the rear visual sensor are configured to obtain a surrounding scene information around the body;
the navigation and positioning system obtains the surrounding scene information collected by the bidirectional visual perception system to position the mowing robot, and builds an operation navigation path according to a positioning information; and
the central control system sends a control signal to the bidirectional movement module according to the operation navigation path, so that the bidirectional movement module controls the chassis system to switch between the forward movement and the backward movement during operation.

Optionally, the chassis system includes a chassis drive module, a power control module, and a suspension module that are connected to each other;
the power control module receives the drive signal sent by the bidirectional movement module to drive the chassis drive module to perform switching between the forward movement and the backward movement; and
the suspension module is configured to adaptively adjust a height and movement angle of the mowing robot.

Optionally, the chassis drive module includes two front drive wheels and two rear drive wheels, each of the front and rear drive wheels is correspondingly connected to an independent power control module, and each of the front and rear drive wheels is driven to rotate by the correspondingly connected power control module.

Optionally, the chassis drive module includes a caterpillar track and a caterpillar-track wheel, and the power control module controls the caterpillar-track wheel to drive the caterpillar track to move.

Optionally, the bidirectional movement module includes a reverse switch motor and a bidirectional drive switch unit, the bidirectional drive switch unit controls a rotation direction of the reverse switch motor according to the received drive signal to control a movement direction of the chassis drive module.

Optionally, the bidirectional visual perception system further includes an image processing module; and
the image processing module is configured to correct the operation navigation path according to the obtained surrounding scene information, and send a corrected operation navigation path to the central control system, so that the central control system sends the control signal according to the corrected operation navigation path.

Optionally, the navigation and positioning system includes a first positioning module and a second positioning module;
the first positioning module is configured to extract a terrain feature from the surrounding scene information, generate an environment map through a SLAM algorithm, and build the operation navigation path based on the environment map; and
the second positioning module is configured to position the mowing robot by using a RTK positioning technology.

Optionally, a mowing system is arranged at the body, and the mowing system is arranged at the bottom of the body and is arranged with a plurality of blades and an electric lifting device that controls a height and position of each blade.

In a second aspect, the present disclosure further provides a mowing-robot control method that is applied to the mowing-robot control system, the method including steps of:
using the bidirectional visual perception system located at the front and rear ends of the body to obtain the surrounding scene information around the body;
using the navigation and positioning system to position the mowing robot according to the surrounding scene information, and to build the operation navigation path according to the positioning information;
sending, by the central control system, the control signal to the bidirectional movement module according to the operation navigation path; and
controlling, by the bidirectional movement module, the chassis system to switch between the forward movement and the backward movement during operation.

Optionally, the bidirectional movement module includes the reverse switch motor. The step of controlling, by the bidirectional movement module, the chassis system to switch between the forward movement and the backward movement during operation includes:

Controlling, by the bidirectional movement module, the rotation direction of the reverse switch motor according to the received drive signal, so that the chassis drive module moves forward or backward under the drive of the reverse switch motor.

In a third aspect, the present disclosure further provides a mowing robot including the mowing-robot control system.

Beneficial effects: The present disclosure provides a mowing-robot control system, a mowing-robot control method, and a mowing robot. By using the bidirectional visual perception system located at the front and rear ends of the body to obtain the surrounding scene information around the body; using the navigation and positioning system to position the mowing robot according to the surrounding scene information, and to build the operation navigation path according to the positioning information; the central control system sending the control signal to the bidirectional movement module according to the operation navigation path; and the bidirectional movement module controlling the chassis system to switch between the forward movement and the backward movement during operation, the method of the embodiment realizes the mowing robot's bidirectional-movement (forward and backward) function through the cooperation of the bidirectional visual perception system, the navigation and positioning system, and the bidirectional movement module, thereby avoiding the space occupation and efficiency loss caused by frequent U-turns during one-direction movement, improving the flexibility of the robot when operating in a complex field, reducing the damage to a lawn during operation, and providing a guarantee for high-precision and high-demand mowing operations.

### BRIEF DESCRIPTION OF DRAWINGS

FIG. 1 is a block diagram of a structural principle of a mowing-robot control system provided by the present disclosure.

FIG. 2 is a schematic structural diagram of a side view of a mowing robot provided by the present disclosure.

FIG. 3 is a schematic structural diagram of a front view of the mowing robot provided by the present disclosure.

FIG. 4 is a schematic structural diagram of a suspension system in the mowing robot provided by the present disclosure.

FIG. 5 is a schematic structural diagram of a mowing device in the mowing robot provided by the present disclosure.

FIG. 6 is a flow chart of steps of a mowing-robot control method of the mowing robot provided by the present disclosure.

### DETAILED DESCRIPTION OF EMBODIMENTS

In order to make the purposes, technical solutions, and advantages of the present disclosure clearer and more specific, the present disclosure is further described in detail below with reference to the accompanying drawings and embodiments. It should be understood that the embodiments described herein are only used to explain the present disclosure and are not used to limit the present disclosure.

With the development of intelligent and automation technologies, a mowing robot has become an important part of smart home and gardening maintenance automation equipment. The mowing robot performs lawn mowing by combining artificial intelligence, sensor devices, and navigation systems. Since the mowing robot replaces manual lawn mowing, the mowing robot improves the operation efficiency and is particularly suitable for the maintenance of a large lawn.

The mowing robot in the prior art is divided into two categories according to its application field: household and commercial. A household mowing robot is characterized by miniaturization and intelligence, suitable for a home lawn, generally controllable by an application program, and equipped with functions such as path planning and intelligent obstacle avoidance. A commercial mowing robot is generally used in a soccer field, a golf course, and public greening, and is characterized by the performance of high efficiency and continuous operation.

Although the automatic control technology for mowing robot continues to improve, the existing mowing robot generally adopts a two-wheel or rear-wheel drive structure that only supports a unidirectional forward operation. During application, in order to complete a turning or U-turn operation on a path, the mowing robot that only supports the unidirectional forward operation often needs to take up extra space and time, repeated U-turns lead to reduced operation efficiency, and the mowing robot does not have the ability to cope with a complex terrain or a narrow area.

In order to solve the above problems in the prior art, the present application provides a mowing-robot control system, a mowing-robot control method, and a mowing robot. The control system includes a chassis system, a bidirectional movement module, a bidirectional visual perception system, a navigation and positioning system, and a central control system. The chassis system receives a drive signal sent by the bidirectional movement module and executes a forward movement or a backward movement. The bidirectional visual perception system obtains surrounding scene information around a body of the mowing robot. The navigation and positioning system obtains the surrounding scene information to position the mowing robot according to the surrounding scene information, and builds an operation navigation path according to positioning information. The central control system sends a control signal to the bidirectional movement module according to the operation navigation path, so that the bidirectional movement module controls the chassis system to switch between the forward movement and the backward movement during operation. The system and method provided by the present disclosure control the bidirectional movement of the mowing robot, so that the mowing robot does not need to perform U-turn, which not only improves the operation efficiency and reduces the space occupation, but also effectively avoids a lawn-wear problem caused by frequent U-turns, better protects the lawn health, and improves the flexibility and intelligence of the mowing robot.

A mowing-robot control system, a mowing-robot control method, and a mowing robot provided by an embodiment are further described in detail below with reference to the accompanying drawings.

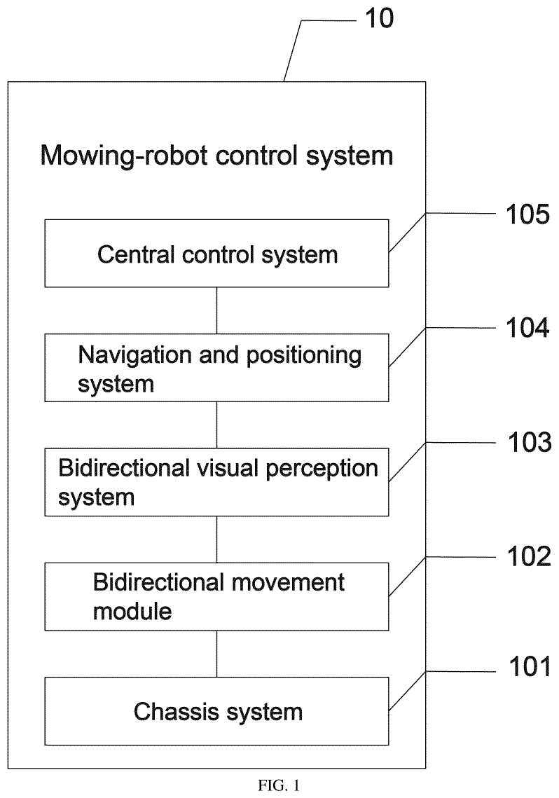

In a first aspect, the present disclosure provides a mowing-robot control system, as shown in FIG. 1, including a chassis system 101, a bidirectional movement module 102, a bidirectional visual perception system 103, a navigation and positioning system 104, and a central control system 105.

The chassis system 101 is arranged on a bottom of a body of the mowing robot and is used to receive a drive signal sent by the bidirectional movement module 102 to execute a forward movement or a backward movement.

The bidirectional visual perception system 103 includes a front visual sensor located at a front end of the body and a rear visual sensor located at a rear end of the body. The front visual sensor and the rear visual sensor are used to obtain surrounding scene information around the body. In one implementation, the front visual sensor and the rear visual sensor may be a laser scanner, a linear-array or area-array Charge-Coupled Device (CCD)/Television (TV) camera, or a digital camera, which includes one or two image sensors that convert an image of an object into a digital signal and process and analyze the image.

The navigation and positioning system 104 obtains the surrounding scene information collected by the bidirectional visual perception system 103 to position the the mowing robot, and builds an operation navigation path according to the positioning information thereof.

The central control system 105 sends a control signal to the bidirectional movement module 102 according to the operation navigation path, so that the bidirectional movement module 102 controls the chassis system 101 to switch between the bidirectional movement (the forward movement and the backward movement) during operation.

The chassis system, the bidirectional movement module, the bidirectional visual perception system, the navigation and positioning system, and the central control system are all arranged on the body of the mowing robot, and are communicatively connected or electrically connected to each other to realize information transmission between these systems and modules.

The bidirectional movement module in the present embodiment receives the control signal transmitted by the central control system, and switches the movement direction of the chassis system by the drive signal controlling a reverse switch motor, thereby realizing the bidirectional movement of the mowing robot.

Further, in combination with FIG. 3, the bidirectional visual perception system is arranged with a front visual sensor 1031 and a rear visual sensor 1032. The front visual sensor 1031 is located at a front end of a top of the body of the mowing robot, and is used to collect surrounding environment information in front of the body. The rear visual sensor 1032 is located at a rear end of the top of the body of the mowing robot, and is used to collect surrounding environment information in rear of the body. Since the front visual sensor 1031 obtains the surrounding environment information in front of the body, and the rear visual sensor 1032 obtains the surrounding environment information in rear of the body, the surrounding environment information obtained from the front and rear visual sensors is spliced to obtain all surrounding environment information of the overall body of the mowing robot, thereby eliminating perceptual blind spots and improving the safety of the mowing robot during operation.

The navigation and positioning system can position the mowing robot based on the surrounding environment information collected by multiple sets of visual sensors, and build the operation navigation path based on the surrounding environment information. The mowing robot can perform corresponding mowing operations according to the built operation navigation path.

The navigation and positioning system sends the built operation navigation path to the central control system, and the central control system can send the control signal to the bidirectional movement module and bidirectional visual perception system of the mowing robot according to the operation navigation path, so as to realize the bidirectional movement module controlling the chassis system to move in a control direction.

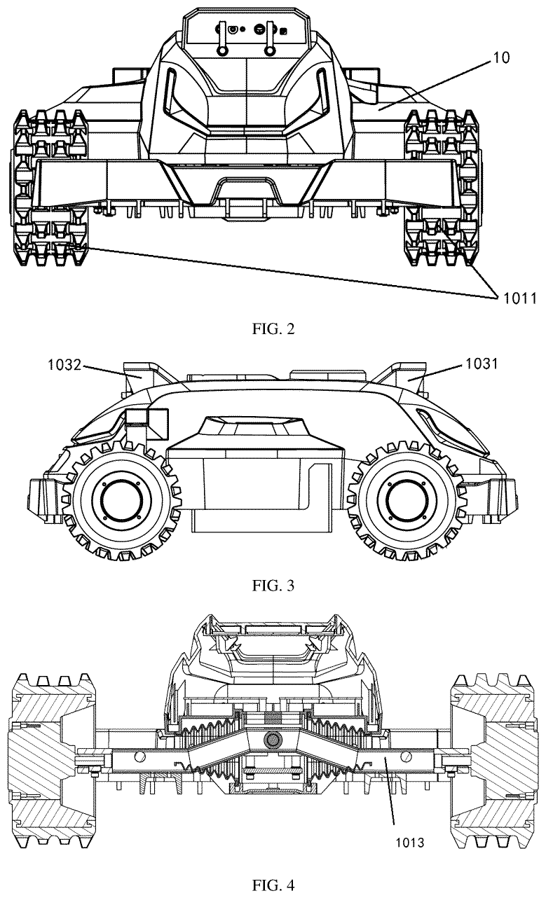

Further, as shown in FIG. 2, the chassis system is located at the bottom of the body, in contact with the ground, and is used to drive the body to move forward or backward. The chassis system 101 may include a chassis drive module, a power control module, and a suspension module that are connected to each other.

The power control module receives the drive signal sent by the bidirectional movement module to drive the chassis drive module to perform switching between the bidirectional movement.

The suspension module is used to adaptively adjust a height and movement angle of the mowing robot.

In one implementation, the chassis drive module adopts a four-wheel drive design, and drives four wheels through independently controlled power transmission systems to drive the body to move forward or backward. The chassis drive module may include two front drive wheels and two rear drive wheels. Each of the front and rear drive wheels is connected to an independent power control module, and each of the front and rear drive wheels rotates under the drive of the correspondingly connected power control module. As shown in FIG. 2 and FIG. 3, the chassis drive module includes four wheels 1011, which are respectively located around the body of the mowing robot and are correspondingly the two front drive wheels and two rear drive wheels. When the body moves forward, a drive signal of a motor is transmitted to the two front drive wheels and two rear drive wheels through the transmission system, so that the front drive wheels and the rear drive wheels rotate forward under power drive. When the mowing robot needs to move backward, the drive signal of the motor is transmitted to the two front drive wheels and two rear drive wheels through the transmission system, so that the front drive wheels and the rear drive wheels rotate backward under power drive. The front and rear drive wheels are all-wheel drive, thus the drive signal of the motor can be directly transmitted to the four wheels. Since the four wheels all can provide power, the traction and off-road capability of vehicle are enhanced.

It is conceivable that the chassis drive module can also adopt another implementation to achieve the bidirectional movement. The chassis drive module may include a caterpillar track and a caterpillar-track wheel. The power control module controls the caterpillar-track wheel to drive the caterpillar track to move. Using a tracked chassis instead of an all-wheel drive four-wheel chassis system can also achieve the bidirectional movement, improve the reliability of the robot in a complex terrain, and improve the operation efficiency.

The power control module independently controls and optimally allocates power to each wheel, thus enhancing the mowing robot's overall active safety, dynamic performance, and movement smoothness.

Since each wheel is driven by an independent motor, the power control module needs to communicate with each motor respectively and receive a feedback signal from a sensor arranged on each wheel, so as to achieve precise control of each vehicle.

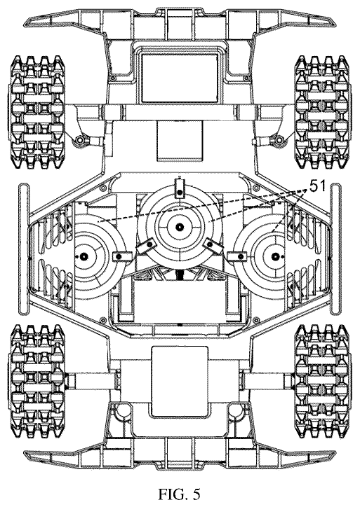

As shown in FIG. 4, the suspension module 1013 is used to adaptively adjust the height and movement angle of the body, is arranged between a chassis of the body and the wheels, and is independently arranged to adapt to an uneven terrain, such as grass, slope, and pothole fields. In one implementation, in order to enable the mowing robot to adapt to different terrain conditions and operation requirements, the suspension module may be arranged with a sensor and a control system. The sensor is used to detect the movement state of the mowing robot and the ground state in real time, and according to a detection result of the sensor, the control system can automatically adjust the stiffness and damping of the suspension module to adapt to different terrain conditions.

The bidirectional movement module may include a reverse switch motor and a bidirectional drive switch unit. The bidirectional drive switch unit controls the rotation direction of the reverse switch motor according to the received drive signal, so as to control the movement direction of the chassis drive module.

The bidirectional movement module is used to control the rotation direction and speed of the reverse switch motor according to the control signal sent by the central control system, so that the mowing robot can flexibly avoid obstacles. The reverse switch motor is a motor that can change its rotation direction, which realizes forward and reverse rotation by changing a direction of current of the motor or a power-supply phase sequence, thereby meeting the direction change requirements of the chassis drive module during movement. In the bidirectional movement module, the reverse switch motor is responsible for providing power and changing its rotation direction according to the received signal. The bidirectional drive switch unit is an electronic control unit that is responsible for receiving the control signal sent by the central control system and controlling the rotation direction of the motor according to a logical state of the control signal (such as high level or low level). When the control signal is in one certain logical state, such as a high level, the bidirectional drive switch unit drives the reverse switch motor to rotate in one direction, and when the drive signal is in another logical state, such as a low level, the bidirectional drive switch unit drives the motor to rotate in a direction opposite to the one direction.

Furthermore, when the bidirectional movement module receives the control signal sent by the central control system, the bidirectional drive switch unit first receives the control signal, determines the logic state of the received control signal, and then sends a corresponding rotation-direction control signal to the reverse switch motor according to a determined logic-state result to change the rotation direction of the reverse switch motor. The movement direction control of the mowing robot is to control the movement direction of the chassis drive module that is directly caused by the change of the rotation direction of the reverse switch motor, therefore by controlling the rotation direction of the reverse switch motor, the movement direction of the chassis drive module can be precisely controlled.

In order to more precisely control the mowing robot during movement, the bidirectional visual perception system further includes an image processing module.

The image processing module is used to correct the operation navigation path according to the obtained surrounding scene information, and send a corrected operation navigation path to the central control system, so that the central control system sends the control signal according to the corrected operation navigation path.

The bidirectional visual perception system can not only capture image information from two different angles to perceive the surrounding scene information around the mowing robot, but also have the image processing module that can perform image preprocessing, feature extraction, stereo matching, and other steps on the image information in a scene captured by a camera, so as to cope with mowing operations and obstacle avoidance in complex conditions.

The bidirectional visual perception system adopts independent front and rear wide-angle sensor modules, combined with deep learning technology and environmental modeling capability, to achieve dynamic obstacle identification, path optimization, and all-round environmental perception, thereby ensuring the safety and efficiency of mowing operations. In one implementation, the bidirectional visual perception system includes front and rear wide-angle camera modules. The front and rear wide-angle camera modules include a wide-angle imaging unit arranged on a front portion of the mowing robot and a wide-angle imaging unit arranged on a rear portion of the mowing robot, where each module includes a Complementary Metal-Oxide-Semiconductor (CMOS) camera component for capturing a high-definition environmental image.

Furthermore, the navigation and positioning system may include a first positioning module and a second positioning module.

The first positioning module is used to extract a terrain feature from the surrounding scene information, generate an environment map through a Simultaneous Localization and Mapping (SLAM) algorithm, and build the operation navigation path based on the environment map. The first positioning module cooperates with the bidirectional visual perception system. The bidirectional visual perception system obtains the surrounding environment information of the body. The first positioning module obtains the surrounding environment information obtained by the bidirectional visual perception system, and uses the SLAM algorithm to generate real-time high-precision terrain modeling, so as to ensure the accurate positioning of equipment in a complex environment. The first positioning module, combined with bidirectional perception technology, ultimately realizes the real-time perception and detour of obstacles in front and rear directions, thereby greatly improving the reliability of the overall navigation system.

The second positioning module is used to position the mowing robot by using Real Time Kinematic (RTK, i.e. real-time dynamic carrier phase differential technology) positioning technology.

The second positioning module uses the RTK positioning technology, which uses a relative-position difference between two or more global navigation satellite system receivers to correct position data in real time. Through a high-precision carrier phase differential algorithm, RTK can reduce an error of conventional satellite positioning from a meter level to a centimeter level.

The two different navigation and positioning technologies provided by the first positioning module and second positioning module can complement each other, so that the mowing robot can still maintain high navigation accuracy in an environment with signal shielding, high interference, or dynamic changes.

Furthermore, the navigation and positioning system further includes a fusion positioning module, which is used to ensure the continuity and accuracy of navigation by switching GPS positioning to visual positioning when a GPS signal is interfered. In the visual positioning, SLAM algorithm works in conjunction with global path planning algorithm.

The navigation and positioning system provided in the present embodiment combines the visual perception capability, RTK positioning technology (centimeter-level positioning technology), and SLAM algorithm of the bidirectional visual perception system, ensuring accurate navigation in a complex environment or when a signal is interfered, thereby achieving highly reliable and intelligent automated mowing operations. The central control system includes a main control chip and a power-supply management module. A core control unit in the main control chip processes all sensor data on the body of the mowing robot, and synchronously coordinates the chassis system, bidirectional movement system, and bidirectional visual perception system to generate a control command. The power-supply management module has a built-in lithium battery pack to provide power for the control system of the mowing robot. In addition, the built-in lithium battery pack in the power-supply management module supports intelligent power control and remaining-power prediction, and further provides the function of automatically returning to a charging station for charging when its power is low.

As shown in FIG. 5, the body is further arranged with a mowing system 51. The mowing system is arranged on the bottom of the body and is arranged with a plurality of blades and an electric lifting device that controls the height and position of each blade.

Furthermore, the electric lifting device is driven by a motor to achieve fast response and precise control. When an operator issues a control command to adjust the height of the blade, the electric lifting device drives an internal transmission mechanism through the motor according to the received command, thereby changing the height of the blade relative to the ground. The electric lifting device can adjust the height of the blade in real time and continuously, so that the blade can be controlled to maintain its best position under different terrains and grass lengths.

The mowing-robot control system disclosed in the present embodiment obtains the surrounding environment information around the body through the bidirectional visual perception system, and uses the navigation and positioning system to build the operation navigation path according to the positioning information and/or the surrounding environment information. The central control system sends the control command to the bidirectional movement module based on the operation navigation path. The bidirectional movement module performs bidirectional movement control on the chassis system based on the control command, so that the mowing robot provided by the present disclosure has the function of the bidirectional (i.e. forward and backward) movement.

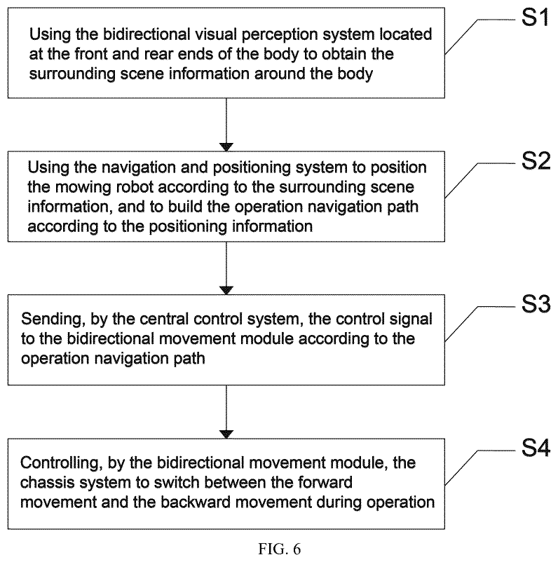

In a second aspect, based on the disclosure of the above-mentioned mowing-robot control system, the present disclosure further provides a mowing-robot control method, as shown in FIG. 6, which is applied to the above-mentioned mowing-robot control system. The control method includes following steps.
Step S1: Using the bidirectional visual perception system located at the front and rear ends of the body to obtain the surrounding scene information around the body.

In the present step, the front visual sensor arranged at the front of the top of the body of the mowing robot and the rear visual sensor arranged at the rear of the top of the body of the mowing robot are used to obtain the environmental information in front and rear of the body, respectively, to identify different types of obstacles around the body, thereby dynamically adjusting path planning through environment modeling. Since the front visual sensor and the rear visual sensor can not only obtain all-round environmental information at the same time, but also have real-time image processing capabilities, they can be combined with a deep learning algorithm to identify and determine different types of obstacles, thereby improving perception capabilities. Especially when it is necessary to alternately switch between the front and rear directions, the perception blind spots can be avoided and the safety of mowing operations can be improved.
Step S2: Using the navigation and positioning system to position the mowing robot according to the surrounding scene information, and to build the operation navigation path according to the positioning information.

The navigation and positioning system can be based on the all-round environment information obtained from the bidirectional visual perception system to achieve accurate positioning of the mowing robot, and can achieve accurate path planning of mowing operations according to the surrounding environment information, therefore flexible adjustment of forward and backward movement paths can be achieved in complex environment scenes.
Step S3: Sending, by the central control system, the control signal to the bidirectional movement module according to the operation navigation path.

The central control system performs corresponding mowing operation according to the operation navigation path built in the navigation and positioning system in the above steps. At the same time, the central control system can further send the control signal to the bidirectional movement module according to data received by various sensors on the body or operation instructions of the operator.
Step S4: Controlling, by the bidirectional movement module, the chassis system to switch between the forward movement and the backward movement during operation according to the received control signal.

The bidirectional movement module obtains the control signal sent by the central control system to control the chassis system of the mowing robot to move forward or backward during operation, so as to switch the movement direction and adjust the movement path.

Furthermore, the bidirectional movement module includes the reverse switch motor. The step of controlling, by the bidirectional movement module, the chassis system to switch between the forward movement and the backward movement during operation includes:

Controlling, by the bidirectional movement module, the rotation direction of the reverse switch motor according to the received drive signal, so that the chassis drive module moves forward or backward under the drive of the reverse switch motor.

The control method disclosed in the present embodiment uses a bidirectional movement mode, so that the robot can adjust its path without repeated U-turns, thereby avoiding the problem of U-turn operations taking up extra space and time, greatly improving the operation efficiency, and especially showing higher flexibility in a narrow area and an obstacle-dense environment.

In a third aspect, the present embodiment further discloses a mowing robot, including the mowing-robot control system.

Since the mowing robot is arranged with the mowing-robot control system provided by the present embodiment, the space occupation and efficiency loss caused by frequent U-turns are effectively avoided, the damage to a lawn caused by turning and crushing the same area during mowing is effectively reduced, and the flexibility of the mowing robot in a narrow area or an obstacle-dense environment is improved.

Furthermore, the mowing robot disclosed in the present embodiment adopts a four-wheel drive chassis design, which significantly improves the robot's ability to pass and stability in complex terrains such as slope, pothole, and slippery grass fields, ensuring efficient operating in complex environments. The application of the bidirectional visual perception technology can achieve all-round environment perception capabilities and improve safety during operation. The mowing robot of the present embodiment further combines the RTK centimeter-level positioning technology with the bidirectional visual positioning (SLAM algorithm) technology to solve the problem of insufficient navigation accuracy of conventional GPS navigation systems under signal interference or occlusion, thereby achieving high-precision path planning and autonomous navigation in complex dynamic environments. Moreover, visual perception and RTK complement each other to achieve the integration of environment perception, precise positioning, and dynamic navigation, thereby ensuring navigation accuracy and continuity of mowing operations under complex operation conditions.

The present disclosure provides a mowing-robot control system, a mowing-robot control method, and a mowing robot. By using the bidirectional visual perception system located at the front and rear ends of the body to obtain the surrounding scene information around the body; using the navigation and positioning system to position the mowing robot according to the surrounding scene information, and to build the operation navigation path according to the positioning information; the central control system sending the control signal to the bidirectional movement module according to the operation navigation path; and the bidirectional movement module controlling the chassis system to switch between the forward movement and the backward movement during operation, the method of the present embodiment realizes the mowing robot's bidirectional-movement (forward and backward) function through the cooperation of the bidirectional visual perception system, the navigation and positioning system, and the bidirectional movement module, thereby avoiding the space occupation and efficiency loss caused by frequent U-turns during one-direction movement, improving the flexibility of the robot when operating in a complex field, reducing the damage to a lawn during operation, and providing a guarantee for high-precision and high-demand mowing operations.

It is understandable that those skilled in the art can make equivalent substitutions or changes based on the technical solutions and inventive concepts of the present disclosure, and all these changes or substitutions should fall within the protection scope of the claims attached to the present disclosure.

What is claimed is:

1. A mowing-robot control system, comprising:
a chassis system,
a bidirectional movement module,
a bidirectional visual perception system, a navigation and positioning system, and
a central control system;
wherein the chassis system is arranged at a bottom of a body of a mowing robot and is configured to receive a drive signal sent by the bidirectional movement module and execute a forward movement or a backward movement;
the bidirectional visual perception system comprises a front visual sensor located at a front end of the body and a rear visual sensor located at a rear end of the body, and the front visual sensor and the rear visual sensor are configured to obtain a surrounding scene information around the body;
the navigation and positioning system obtains the surrounding scene information collected by the bidirectional visual perception system to position the mowing robot, and builds an operation navigation path according to a positioning information; and
the central control system sends a control signal to the bidirectional movement module according to the operation navigation path, so that the bidirectional movement module controls the chassis system to switch between the forward movement and the backward movement during operation.

2. The mowing-robot control system according to claim 1, wherein the chassis system comprises a chassis drive module, a power control module, and a suspension module that are connected to each other;
the power control module receives the drive signal sent by the bidirectional movement module to drive the chassis drive module to perform switching between the forward movement and the backward movement; and
the suspension module is configured to adaptively adjust a height and movement angle of the mowing robot.

3. The mowing-robot control system according to claim 2, wherein the chassis drive module comprises two front drive wheels and two rear drive wheels, each of the front and rear drive wheels is correspondingly connected to an independent power control module, and each of the front and rear drive wheels is driven to rotate by the correspondingly connected power control module.

4. The mowing-robot control system according to claim 2, wherein the chassis drive module comprises a caterpillar track and a caterpillar-track wheel, and the power control module controls the caterpillar-track wheel to drive the caterpillar track to move.

5. The mowing-robot control system according to claim 2, wherein the bidirectional movement module comprises a reverse switch motor and a bidirectional drive switch unit, the bidirectional drive switch unit controls a rotation direction of the reverse switch motor according to the received drive signal to control a movement direction of the chassis drive module.

6. The mowing-robot control system according to claim 1, wherein the bidirectional visual perception system further comprises an image processing module; and
the image processing module is configured to correct the operation navigation path according to the obtained surrounding scene information, and send a corrected operation navigation path to the central control system, so that the central control system sends the control signal according to the corrected operation navigation path.

7. The mowing-robot control system according to claim 1, wherein the navigation and positioning system comprises a first positioning module and a second positioning module;
the first positioning module is configured to extract a terrain feature from the surrounding scene information, generate an environment map through a simultaneous localization and mapping (SLAM) algorithm, and build the operation navigation path based on the environment map; and
the second positioning module is configured to position the mowing robot by using a real time kinematic (RTK) positioning technology.

8. The mowing-robot control system according to claim 1, wherein a mowing system is arranged at the body, and the mowing system is arranged at the bottom of the body and is arranged with a plurality of blades and an electric lifting device that controls a height and position of each blade.

9. A mowing-robot control method applied to the mowing-robot control system according to claim 1, the method comprising steps of:
using the bidirectional visual perception system located at the front and rear ends of the body to obtain the surrounding scene information around the body;
using the navigation and positioning system to position the mowing robot according to the surrounding scene information, and to build the operation navigation path according to the positioning information;
sending, by the central control system, the control signal to the bidirectional movement module according to the operation navigation path; and
controlling, the bidirectional movement module, the chassis system to switch between the forward movement and the backward movement during operation.

10. A mowing robot, comprising the mowing-robot control system according to claim 1.
